(19) United States
(12) Patent Application Publication
(10) Pub. No.: US 2026/0357034 A1
(43) Pub. Date: Nov. 12, 2026

(54) ACTIVATED PYROLYTIC CARBON BLACKS RECOVERED FROM USED TYRES AND PREVIOUSLY PURIFIED AND THE APPLICATION THEREOF IN THE PRODUCTION OF COMPOUNDS FOR THE RUBBER INDUSTRY, SUCH AS COMPONENTS FOR NEW TYRES OR FOR NEW TECHNICAL ARTICLES

(71) Applicant: T.E.C. S.R.L., Milano (IT)

(72) Inventors: Franco CATALDO, Milano (IT); Angelo PRIORI, Milano (IT)

(73) Assignee: T.E.C. S.R.L., Milano (IT)

(21) Appl. No.: 19/142,274

(22) PCT Filed: Dec. 21, 2023
(86) PCT No.: PCT/IT2023/050293

§ 371 Date: Jun. 23, 2025

(30) Foreign Application Priority Data
Dec. 23, 2022 (IT) 102022000026754

(51) Int. Cl. C08K 3/04; C08C 4/00; C09C 1/48

(52) U.S. Cl. CPC C08K 3/04; C08C 4/00; C09C 1/482

(57) ABSTRACT

The pyrolytic carbon black derived from used tyres undergo purification processes that make it more environmentally compatible and, subsequently, a surface activation process imparted thereto reinforcing properties, when used as a reinforcing filler in new rubber compounds, is decidedly superior to those imparted by a common commercially available pyrolytic carbon black and comparable to the mechanical properties produced by conventional “furnace” blacks of the N772, N550 and N330 type.

### BACKGROUND

The pyrolysis of used tyres produces a carbon black, hereinafter also called pyrolytic carbon black (which hereinafter in the present description will be indicated by the acronym CBp). In particular, the CBp directly obtained from pyrolysis, called crude pyrolytic carbon black (which hereinafter in the present description will be indicated by the acronym CBp-0), is contaminated by pyrolytic rubber residues. These pyrolytic residues also contain a rich mixture of polycyclic aromatic hydrocarbons (PAHs), some of them notoriously carcinogenic, which are incorporated in the bituminous-tar mass of the pyrolytic rubber residues [cf.: F. Cataldo, (2020). On the characterisation of carbon black from tire pyrolysis. Fullerenes, Nanotubes and Carbon Nanostructures, 28: 368-376; F. Cataldo, (2021). Pyrolytic carbon black frorn truck tires: some new analytical approaches. Fullerenes, Nanotubes and Carbon Nanostructures, 29: 304-314]. Ultimately, CBp-0 is a product of little commercial value, which cannot be used as a reinforcing material in new rubber compounds, due both to its scant reinforcing capacity and the presence of hazardous PAHs.

WO2021/079395A1 describes processes adapted to purify the CBp-0 obtained from the pyrolysis of used tyres. In particular, WO2021/079395A1 describes both processes for the purification of CBp-0 by extraction with solvents having zero toxicity and a low environmental impact, adapted to remove the pyrolytic rubber residues together with the PAHs, and heat treatments of CBp-0, adapted to vaporise the aforesaid pyrolytic rubber residues together with the PAHs. In particular, the heat process revealed to be more practical, faster, and more economical, as it can be applied directly at the end of the pyrolysis of the used tyres without necessarily having to isolate the CBp-0. In fact, as described in WO2021/079395A1, it is sufficient to maintain the CBp-0 at 600 °C-700 °C under a nitrogen flow for a few dozen minutes to completely remove the residual bituminous fraction and the associated PAHs contained therein. The resulting pyrolytic carbon black thus purified (called CBp-1 to distinguish it from the starting CBp-0) is free of pyrolytic rubber residues and PAHs, but nonetheless poses a series of problems that do not make it particularly appealing, as a reinforcing material, to manufacturers of high-end tyres.

In particular, the main problem of CBp-1 is the high zinc and sulphur content. In fact, during the pyrolysis of used tyres, zinc sulphide (ZnS) is formed, and it remains inevitably entrapped in the CBp-1. If the CBp-1 is used as a reinforcing filler in new compounds for tyres or technical articles, the presence of ZnS can interfere with the vulcanisation kinetics. Furthermore, zinc is notoriously toxic for aquatic microorganisms, certain fish, and other invertebrates [. F. Skidmore, (1964). Toxicity of zinc compounds to aquatic animals, with special reference to fish. The Quarterly Review of Biology, 39: 227-248; S. F. Brinkman, et at. (2012). Acute toxicity of zinc to sever at aquatic species native to the Rocky Mountains. Archives of Environmental Contamination and Toxicology, 62: 272-281]. Zinc in ionic form is released by tyres into the environment during leaching by rainwater. Thus, there is a growing focus on reducing zinc in rubber formulations, especially for tyres, with the aim of minimising its diffusion in the environment. The presence of ZnS does not favour the widespread use of CBp-1 as an ecological material. All the more so as the presence of ZnS performs no technological function; indeed, it interferes with vulcanisation kinetics. In fact, in rubber compounds with CBp-1 as a filler, it is always necessary to add zinc oxide (ZnO) as a vulcanisation activator.

WO2021/079395 A1 describes a process for the acid purification of CBp-1, said process being adapted to remove ZnS according to the general reaction

ZnS+2H⁺→Zn²⁺+H₂S

This reaction can be carried out through the use of mineral acids or, alternatively, using biodegradable carboxylic acids derived from renewable sources. The purification treatment removes not only the zinc and sulphur, but also a series of transition metals, such as, for example, Cr, Co, Cd, Pb (considered toxic to living organisms and the environment), bringing them to very low concentrations. Therefore, the resulting product of the purification of CBp-1 is a product with high added value (which in WO2021/079395A1 and hereinafter in the present description is called CBp-2), and having a low zinc and sulphur content and a very low transition metal content it is an ecological product.

However, CBp-2 can still contain variable contents of silica, likewise derived from the pyrolysis of used tyres. The silica is not a problem for the purposes of reusing CBp-2 in new rubber compounds. However, for certain particular applications, a CBp completely free of silica, too, can be required. By changing the mixture of purifying acidic agents, as described in WO2021/079395A1, it is possible also to remove the silica, thus obtaining an absolutely clean product (which in WO2021/079395A1 and hereinafter in the present description is called CBp-3).

TABLE 1
Chemical analyses of the carbon black (CBp)
obtained from the pyrolysis of used tyres

| | Unit of | Commercial | CBp-1 | CBp-2 | CBp-3 |
|---|---|---|---|---|---|
| | measurement | CBp | (*) | (*) | (*) |
| ASH | % | >20 | 15 | <7.5 | <0.2 |
| Sulphur | % | 2.1 | 3.0 | 0.5 | 0.7 |
| Iron | % | 0.51 | 0.65 | 0.019 | 0.018 |
| Zinc | % | 3.0 | 5.5 | 0.07 | 0.07 |
| Chromium | ppm | 23.3 | 14.5 | 9.9 | 10.0 |
| Manganese | ppm | 31.2 | 31.5 | <0.2 | <0.2 |
| Cobalt | ppm | 424 | 207 | 6.1 | 5.5 |
| Nickel | ppm | 14.5 | 9.5 | 3.0 | 0.8 |
| Arsenic | ppm | 26.2 | 4.4 | 1.7 | 2.5 |
| Cadmium | ppm | 20.8 | 3.2 | 1.3 | 1.5 |
| Tin | ppm | 12.2 | 7.6 | 9.4 | 8.7 |
| Antimony | ppm | 23.1 | 24.4 | 17.5 | 11.3 |
| Lead | ppm | 43.3 | 40.5 | 7.1 | 6.0 |
| Surface | m²/g | 70 | 50-70 | 65-70 | 65-70 |
| area | | | | | |
| (**B.E.T. | | | | | |
| method) | | | | | |

(*) obtained in accordance with the patented process in WO2021/079395 A1
**standard as per ASTM D-6556

Table 1 shows the elementary analyses by X-ray fluorescence of the products CBp-1, CBp-2, and CBp-3 and the respective ash content compared to a commercial CBp.

Table 1 shows that a commercial CBp does not differ much from CBp-1, either in the content of some transition metals or in that of some metalloids. As regards the zinc, sulphur and ash content, the differences between commercial CBp and CBp-1 are more marked, being tied to the nature of the starting tyres used for pyrolysis. However, for the purposes of the invention, the origin and nature of the tyres used for pyrolysis has little importance and must not be viewed as limiting factors. In fact, the present invention is applicable to CBp of any origin. What counts, as is shown, moreover, in Table 1, is the excellent ecological qualities, especially of the CBp-2 and CBp-3 derived from the purification process described in WO2021/079395A1. In fact, in CBp-2 the ash (essentially silica) is reduced to less than 7.5% and is practically absent in CBp-3. The content of iron (which is a pro-oxidant agent for reuse in new rubber compounds) in CBp-2 and CBp-3 is found to be below 0.02%, whereas zinc (toxic to aquatic life, cf. [Skidmore (1964); Brinkman, et al. (2012) cit.]) is brought by purification from initial values of over 5% in CBp-1 to the insignificant concentration of 0.07% in CBp-2 and CBp-3. Consequently, the sulphur content of CBp-1, which is at least in part bound to zinc as ZnS, is lowered towards 0.5-0.7% in CBp-2 and CBp-3 as a result of the purification process, thereby reducing the risk of an interference thereof with the vulcanisation kinetics should CBp-2 and CBp-3 be used as reinforcing fillers in new compounds. The benefit of the purification of CBp-1 is also to be seen in the content of certain transition metals such as Mn, Co, Ni and Pb. The concentration of such metals, rather significant and concerning (see the case of Co) in the starting CBp-1, is reduced to minimum levels in CBp-2 and CBp-3 as a result of purification. In examples 1-5 below, the pyrolytic carbon black production and purification processes described in WO2021/079395A1 are detailed.

### Example 1

In a rotary tube furnace, CBp-1 was produced from the pyrolysis of used tyres (hereinafter indicated by the acronym ELTs) as described below. The furnace was loaded with 3500 g of end-of-life tyres, pre-ground to 325 mesh. The load of tyre powder was brought to 600 °C, a temperature that was maintained until the completion of pyrolysis, when about 1150 g of residual carbon black remained in the reactor. Upon completion of the pyrolysis, the resulting CBp was brought to 660 °C and maintained under a flow of nitrogen at this temperature for 75 minutes. Alternatively, it is possible to rise to 700 °C under a flow of nitrogen and maintain that temperature for 45 minutes in order to complete the “cleaning” of the CBp to remove pyrolytic rubber residues and PAHs and produce CBp-1. The resulting CBp-1, collected from the reactor and cooled to room temperature, was transferred in an amount of 1000 g into a Duran glass jacketed reactor with a capacity of 5L and equipped with a stirrer. A bubble cooler connected by means of a tap with a Dreschel bottle filled with 1L of 10% NaOH solution, a valve for the introduction of inert gas (for example nitrogen) and a drip funnel loaded with 3000 mL of 20% hydrochloric acid were placed at the top of the reactor. The purification was carried out by letting the hydrochloric acid fall quickly onto the CBp-1 under stirring, so as to create a fluid slurry. The reactor was heated to a temperature comprised between 60 and 90 °C to facilitate purification. The hydrochloric acid reacted with the zinc sulphide present in the CBp-1 (which if originating from OTR (off-the-road) tyres contains up to 82 g/kg thereof; if originating from PSR (passenger) tyres, i.e. tyres for passenger vehicles, or TBR (truck and bus) tyres, i.e. tyres for lorries and buses, the ZnS content is decidedly lower), decomposing it according to the reaction:

ZnS+2HCl→ZnCl₂+H₂S

The zinc was leached out and passed into the aqueous solution, whilst the hydrogen sulphide was released in gaseous form and was conveyed into the Drechsel bottle by a flow of nitrogen (or another inert gas, for example compressed air) which caused it to bubble in the NaOH solution, where it was trapped as sodium sulphide:

H₂S+2NaOH→Na2S+2H₂O

The purification reaction was relatively quick, and the removal of zinc was almost complete in 30 minutes. Then followed filtration of the reaction slurry in a Buchner filter and the cake of CBp-2 that formed on the filter paper was repeatedly washed with water until the washing water showed neutrality (at least pH=5.5-6.0). At that point, the moist cake of CBp-2 was transferred into a dryer, where it was completely freed of the residual water. The yield in CBp-2 after purification was 91.5% out of the starting CBp-1 (the yield can be higher than 91.5% depending on the ELT mixture from which the CBp-1 is derived). An analysis of the CBp-2 by X-ray fluorescence showed the analytic composition reported in Table 1, whereas the ash was determined by means of thermogravimetric curve analysis in an air flow up to 850 °C. The surface area of the CBp-2 measured through nitrogen absorption (B.E.T. method) showed a value comprised between 65 and 70 m²/g, as reported in Table 1.

### Example 2

One proceeded exactly as in example 1, with the only difference being that the purifying mixture was composed of 3000 mL of 6.0 M hydrochloric acid and 3.0 M hydrofluoric acid. In this case the purification was not limited to solubilising the zinc and removing the sulphur by decomposition of the ZnS as in example 1, as it also proved to be effective in solubilising and removing the silica present in the CBp-1. In fact, HF dissolved the silica according to the reaction

6HF+SiO2→H₂SiF₆+2H₂O

solubilising it in the form of hexafluorosilicic acid. Silica was present in the CBp-1, as it is by now widely disseminated as a reinforcing filler, which is added to tyre compounds as a reinforcing filler in the same way as furnace carbon black. The subsequent operations of filtering and drying the resultant CBp-3 were identical to those previously described in example 1. Analyses of the resultant CBp-3 performed by X-ray fluorescence showed the elementary composition reported in Table 1, whereas the ash of the CBp-3 was determined by means of thermogravimetric curve analysis in an air flow up to 850 °C. As expected, the CBp-3 showed to be completely free of ash. The surface area of the CBp-3, measured by nitrogen absorption (B.E.T. method), showed a value comprised between 65 and 70 m²/g, as reported in Table 1.

In general, commercial CBp-Is show a limited reinforcing capacity in relation to the expectations arising from the surface area measurement. Evidently, despite the large surface area, the surface of CBp-1 is not very active and scarcely suitable for the chemisorption and physisorption processes that are at the basis of the reinforcement mechanisms in rubber compounds. The same problem presents itself also in the case of the CBp-2 and CBp-3 of examples 1 and 2. Like the commercial CBp-1s, both the CBp-2 and CBp-3 are subjected to conventional grinding processes, more precisely micronization, before they can be reused in rubber compounds. Micronization breaks down carbon black agglomerates as well as, in part, the aggregates, reducing the diameter of agglomerates to below 40 μm. Micronization facilitates the dispersion of CBp in the rubber matrix and enhances its reinforcing capacity. However, despite the micronization, the reinforcing effect of the various types of CBp is very often below expectations.

### SUMMARY

The solution according to the present invention fits into this context; it aims to provide a process for recovering carbon black obtained from the pyrolysis of used tyres which enables the limits of the purification processes according to the prior art to be overcome.

### DETAILED DESCRIPTION OF EMBODIMENTS

These and other results are obtained according to the present invention by proposing a process for recovering carbon black obtained from the pyrolysis of used tyres comprising the following steps:
heat treatment of the carbon black in an inert atmosphere at a temperature comprised between 550 °C and 800 °C to obtain a purified carbon black (CBp-1), optionally further purified through a subsequent step of
selective extraction of the zinc from the purified carbon black (CBp-1) using an aqueous solution comprising a carboxylic acid selected from citric acid and tartaric acid or an inorganic acid selected from hydrochloric acid and sulphuric acid, preferably an inorganic acid selected from hydrochloric acid and sulphuric acid, to obtain a purified carbon black with a low zinc and sulphur content (CBp-2), said aqueous solution optionally further comprising hydrofluoric acid, in combination with said carboxylic acid or said inorganic acid, to obtain a purified carbon black with a low silica content (CBp-3), the process further comprising a step of
activation of the surface of the purified carbon black using reactive gases selected from nitrogen, argon, carbon dioxide, superheated steam, and mixtures thereof and preferably from carbon dioxide, superheated steam, and mixtures thereof.

Preferably, according to the invention, said heat treatment in an inert atmosphere takes place at a temperature comprised between 600 °C and 780 °C and under a stream of an inert gas selected from: N₂, Ar, CO₂, superheated steam, or a combination thereof.

In particular, likewise according to the invention, said step of activating the surface of the purified carbon black using reactive gases is carried out by means of a flow of CO₂ and/or superheated steam comprised between 150 and 400 ml/min, with a heating ramp comprised between 10°/min and 40 °C/min, up to a final temperature comprised between 800 °C and 950 °C, with a dwell time at that final temperature comprised between 30 and 60 minutes.

A further object of the present invention is a recovered carbon black as obtained from the previously defined process, as well as the use of that recovered carbon black in the production of rubber compounds.

According to the present invention, it was in fact surprisingly discovered that by applying a step of surface etching (or surface activation) with reactive gases on micronized CBp-1, CBp-2, and CBp-3 it is possible not only to control and above all increase the surface area of the carbon black, but also to activate the surface in such a way that it is richer in active sites and thus readier both for chemisorption and physisorption of the rubber, thus ending up not only equaling but even surpassing the reinforcing effect of “furnace” blacks, which are the conventional carbon blacks obtained from petroleum. In other words, a method was found for reactivating the surface of the CBp-1 and especially of the CBp-2 and CBp-3 by surface etching with reactive gases. With this treatment the CBp-2 and CBp-3 give rise to a considerable and surprising reinforcing effect that is not observable in similar non-activated CBps, when used as a reinforcing filler in new rubber compounds. Therefore, CBp-2 and CBp-3, besides being ecological carbon blacks, in that they are free of zinc, sulphur, toxic transition metals, and silica (in the case of CBp-3), also become highly reinforcing carbon blacks, after undergoing the etching process with reactive gases as detailed in the next example 3.

### Examples 3-5

A Carbolite-Gero horizontal “TSO Rotary Reactor Tube Furnace” equipped with a semi-rotating fluted quartz reactor vessel was loaded with 300 g of CBp-1 or CBp-2 or CBp-3 (according to what is detailed in Table 2). The abovementioned pyrolytic carbon black had already undergone micronization and sieving <40 μm. The selected CBp was heated under a continuous flow of carbon dioxide (CO₂) up to a temperature of 800 °C or another temperature, as reported in Table 2. That temperature was then maintained for a pre-established time (as detailed in Table 2), again under a continuous gas flow, whilst the pre-selected CBp powder was remixed under the semi-rotary movement of the quartz reactor vessel. At the end of the treatment, it was allowed to cool to room temperature, again strictly under a flow of CO₂. The selected CBp, activated with reactive gas, was subjected to analyses, whose results are shown in Table 2, and subsequently used for tests in the rubber compound of the subsequent examples.

The effect of the reactive gases is evident in Table 2: they result in a considerable increase in the surface area of the CBp and, in fact, enable that surface area to be controlled simply by changing the reaction temperature (as illustrated in Table 2) or the reaction times. Following such treatments, the surface areas of the CBp can even be doubled compared to the starting values of the crude CBp. In fact, as illustrated in Table 2, the CBp-1 went from the initial 50 m²/g to 98 m²/g, whereas the CBp-2 and CBp-3 went from the initial 65-70 m²/g to values exceeding 110 m²/g. Another effect of the action of CO₂ on the pyrolytic carbon black regarded the imparting of a certain degree of microporosity to the treated carbon blacks, where such microporosity was nearly absent in the starting CBp. Whereas the surface area was measured by means of the standard B.E.T method as per ASTM D-6556, microporosity was determined through the difference between the value of the B.E.T surface area and that of the STSA (Statistical Thickness Surface Area) procedure, likewise standard as per ASTM D-6556. In the absence of microporosity, the B.E.T. and STSA surface areas coincide, whilst the value derived from the difference [B.E.T.]-[STSA] corresponds to the microporosity value.

TABLE 2
Examples 3-5 relating to the activation of previously
micronized CBp-1, CBp-2, and CBp-3

| | | Ex. 3 | Ex. 4 | Ex. 5 |
|---|---|---|---|---|
| | Unit of | CBp-1 | CBp-2 | CBp-3 |
| | measurement | (*) | (*) | (*) |
| Flow of CO₂ | mL/min | 150 | 250 | 400 |
| Heating ramp | °C/min | 10 | 20 | 40 |
| Final temperature | °C | 800 | 900 | 950 |
| Dwell time at the final | Min | 60 | 40 | 30 |
| temperature | | | | |
| Initial surface area | m²/g | 50 | 65-70 | 65-70 |
| (measured by absorption | | | | |
| of N₂ ASTM D-6556) | | | | |
| Final surface area after | m²/g | 98 | 111 | 115 |
| activation with CO₂ | | | | |
| (measured by absorption | | | | |
| of N₂ B.E.T. method = | | | | |
| ASTM D-6556) | | | | |
| Finale microporosity | m²/g | 9 | 12 | 12 |
| after activation with | | | | |
| CO₂ (Understood as | | | | |
| [B.E.T.]-[STSA] | | | | |
| ASTM D-6556) | | | | |

(*) obtained in accordance with the patented process in WO2021/079395 A1 and examples 1-3

In order to further characterise the CBp-1, CBp-2, and CBp-3 of the previous examples 3-5, a series of structural parameters were determined by X-ray diffraction using as the reference carbon black a conventional so-called “furnace” black derived from petroleum and having the ASTM code N772. The basic structural parameters that are typically used to “fix” the structural characteristics of amorphous carbon blacks were obtained from the X-ray diffraction data.

The formulas for calculating such parameters are detailed for example by Ismagilov, Z R., et al. (2019). Structural analysis of needle coke. Coke and Chemistry, 62: 135-142, whereas the parameters calculated from the X-ray diffractograms are shown both for N772 and each CBp at the bottom of Table 3 and comprise the interplanar distance of the graphene planes (d₀₀₂), the packing density of the graphene planes (p), the longitudinal dimensions of the structural planes (La), the thickness of the superimposed graphene layers (Lc) and, finally, the number of graphene layers in each “crystallite” (N). From the structural parameters reported in Table 3, one may infer a considerable structural analogy between the “furnace” black N772 taken as a reference and the carbon blacks CBp-1, CBp-2, and CBp-3 obtained from the pyrolysis of used tyres and, in the case of the latter two, after adequate acid purification.

TABLE 3
Structural parameters of CBp determined by X-ray diffraction
compared with furnace black N772 taken as a reference

| | N772 | | | | |
|---|---|---|---|---|---|
| | (Reference | | | | |
| | furnace black) | CBp-1 | CBp-2 | CBp-3 | Notes |
| 2 theta deg | 24.81 | 25.33 | 24.85 | 24.99 | Peak 002 |
| 2 theta rad | 0.433 | 0.442 | 0.434 | 0.436 | Peak 002 |
| d (A) | 3.59 | 3.51 | 3.58 | 3.56 | Interplanar distance 002 (Å) |
| FWHM DEG | 6.40 | 5.47 | 6.05 | 6.39 | Full width at half maximum (degrees) |
| FWHM rad | 0.112 | 0.095 | 0.106 | 0.111 | Full width at half maximum (radians) |
| 2 theta deg | 43.54 | 43.65 | 43.81 | 43.71 | Peak 100 |
| 2 theta rad | 0.760 | 0.762 | 0.765 | 0.763 | Peak 100 |
| d (A) | 2.08 | 2.07 | 2.06 | 2.07 | Interplanar distance peak 100 (Å) |
| FWHM DEG | 6.39 | 9.94 | 5.49 | 7.14 | Full width at half maximum (degrees) |
| FWHM rad | 0.112 | 0.173 | 0.096 | 0.125 | Full width at half maximum (radians) |
| d₀₀₂ | 3.58 | 3.52 | 3.58 | 3.56 | Interplanar distance (Å) |
| ρ | 2.13 | 2.17 | 2.13 | 2.14 | Layer packing density (g/cm³) |
| Lc (002peak) | 11.15 | 12.98 | 11.78 | 11.15 | Thickness of polyarylene layers (Å) |
| La (10I peak) | 18.45 | 11.82 | 21.35 | 16.44 | Longitudinal dimension of structural |
| | | | | | lamellae (Å) |
| N | 4.3 | 5.2 | 4.6 | 4.4 | Number of polyarylene layers in the pack |

Another characterising result derived from the X-ray diffraction analysis of the non-activated CBp-1 regards the presence of ZnS in the crystalline modification known as sphalerite, easily identified by the presence of the reflections X at 2θ=28.450; 47.435; 56.269. The polymorph that forms at high temperature from sphalerite is the crystalline modification of ZnS known as wurtzite. The X-ray diffraction of the heat-activated CBp-1 is distinguished from the non-activated CBp-1 precisely because of the presence of wurtzite with the characteristic reflections at 2θ=26.8074; 28.4810; 30.460; 39.453; 47.4579; 51.662; 56.289. The characterising aspect under X-ray diffraction analysis of both the CBp-2 and CBp-3, activated or non-activated, concerns the complete absence of any reflection due to the crystalline structure of sphalerite or wurtzite, all the zinc present having been completely removed through the purification process.

As illustrated in the following examples, it was further surprisingly found that pyrolytic black carbons obtained from ELTs, purified according to examples 1-2 and activated according to examples 3-5, if used as reinforcement materials in rubber compounds, give rise to reinforcing effects that are decidedly superior to those imparted by a commercial CBp or even “furnace” blacks, i.e. derived from petroleum, such as, for example, carbon black N772. Therefore, an object of the present invention is the surface activation of the CBp-1, CBp-2, and CBp-3 according to examples 3-5 and the consequent surprising reinforcing effect imparted to the rubber compounds of examples 6-12.

### Examples 6-12

The pyrolytic carbon black from ELTs CBp-1, prepared according to patent WO2021/079395 A1, and the pyrolytic carbon blacks CBp-2 and CBp-3, prepared according to what was described in examples 1 and 2, were subjected to activation as described in examples 3-5, and were then tested in the following standard natural rubber-based formulation: natural rubber (cis-1,4-polyisoprene from Hevea Brasiliensis, type CV60): 100 phr (“phr” indicates the parts of each component of the formulation added per every 100 parts of rubber, and is the method of expressing a rubber formulation typical of the sector); carbon black: 52 phr (the “furnace” blacks, i.e. derived from petroleum, were N330, N550 and N772 and were used as reference materials, whereas the CBp-1, CBp-2 or CBp-3 prepared according to examples 3-5 were used as pyrolytic carbon blacks. A commercial CBp was also used as a further reference material); plasticising oil type T-DAE (Treated Distillate Aromatic Extract, i.e. of an aromatic nature): 5 phr; stearic acid: 1 phr; zinc oxide (3 phr); IPPD (isopropyl-phenyl-p-phenylenediamine) as an antiozonant: 1.5 phr; TMQ (polymerised trimethyl-quinoline) as an antioxidant: 1 phr; sulphur: 1.5 phr and CBS (cyclohexylbenzothiazole-sulfenamide) as an accelerator: 1.5 phr.

Each rubber compound of examples 6-12 was prepared using a 1.5 litre laboratory mixer (Banbury) which allows >1 kg of compound to be prepared per batch. The components of the compound as formulated in the previous paragraph were carefully weighed, respecting the proportions of the formulation. The sequence of addition into the mixer first comprised the rubber, which was allowed to be masticated by the machine for a couple of minutes. Then the carbon black (which is the only component that varies from compound to compound in examples 6-12, the type added being shown in Table 4 for every example) was added together with the plasticising oil. The carbon black was allowed to blend thoroughly with the rubber and oil and, finally, the zinc oxide, stearic acid, antiozonant agent and antioxidant agent were added. Mixing continued until a homogeneous compound was obtained, which was then unloaded from the Banbury and reduced into a thin layer about 0.5 cm thick by repeated passing through a special mill, known to the person skilled in the art. The compound thus prepared was allowed to cool at room temperature. Once cold, the compound was again loaded into the Banbury and the vulcanising agents (sulphur and accelerator) were added after being weighed to respect the proportions of the formulation. Mixing continued until a homogeneous compound was reached. The compound thus obtained was unloaded from the Banbury, then reduced to a thin layer by repeated passing through the mill and subsequently allowed to cool at room temperature. For vulcanisation, quantities of compound sufficient to fill the mould for a test specimen were drawn for technological tests according to ASTM or UNI standards (see Table 4 for the standard followed for each technological test) and vulcanised in a press by heating at 160 °C for 15 min in the case of thin test specimens and 20 min in the case of larger test specimens. The technological tests on the vulcanised specimens were carried out according to ASTM or UNI standards. Each standard chosen and applied in the technological test is shown in Table 4.

TABLE 4
Natural rubber-based compounds (NR, cis-1,4-polyisoprene)

| | | | compar- | compar- | compar- | compar- | | | |
|---|---|---|---|---|---|---|---|---|---|
| | | | ative | ative | ative | ative | | | |
| | | | example | example | example | example | | | |
| | | | 6 | 7 | 8 | 9 | | | |
| | | | N330 | N550 | N772 | Commercial | | | |
| Vulcanised | | | compar- | compar- | compar- | CBp | example | example | example |
| at 160 °C- | | Unit of | ative | ative | ative | compar- | 10 | 11 | 12 |
| 15 min | Method | measurement | test | test | test | ative test | CBp-1 | CBp-2 | CBp-3 |
| Hardness | ASTM D | Sh/A3 | 59 | 57 | 55 | 55 | 56 | 59 | 60 |
| (Shore A) | 2240-15 | | | | | | | | |
| Density of | ASTM D | g/cm³ | 1.105 | 1.105 | 1.104 | 1.111 | 1.112 | 1.107 | 1.107 |
| vulcanised | 792-20 | | | | | | | | |
| rubber | | | | | | | | | |
| Tensile | ASTM D | Mpa | 21.2 | 19.7 | 17.6 | 16.3 | 22.7 | 24.1 | 23.9 |
| Strength | 412-16 | | | | | | | | |
| Modulus at | ASTM D | Mpa | 2.51 | 2.84 | 1.79 | 1.96 | 2.15 | 2.26 | 2.43 |
| 100% | 412-16 | | | | | | | | |
| elongation | | | | | | | | | |
| Modulus at | ASTM D | Mpa | 11.2 | 12.8 | 8.84 | 8.6 | 8.56 | 9.34 | 10.2 |
| 300% | 412-16 | | | | | | | | |
| elongation | | | | | | | | | |
| Elongation | ASTM D | % | 520 | 433 | 565 | 517 | 565 | 540 | 505 |
| at Break | 412-16 | | | | | | | | |
| Tear | ASTM D | KN/m | 128 | 107.6 | 89 | 91 | 121 | 125 | 119 |
| Strength | 624-00 | | | | | | | | |
| | B | | | | | | | | |
| Abrasion | UNI | mm³ | 101 | 123 | 195 | 153 | 128 | 123 | 119 |
| Loss | 9185- | | | | | | | | |
| | 2008 | | | | | | | | |
| Rebound | UNI | % | 58 | 61 | 67 | 59 | 60 | 61 | 63 |
| Resilience | 7716- | | | | | | | | |
| | 2000 | | | | | | | | |
| Permanent | ASTM | % | 12 | 13 | 10 | 12 | 10 | 11 | 11 |
| Deformation | D395-18 | | | | | | | | |
| under | B | | | | | | | | |
| compression | | | | | | | | | |
| (70 °C) | | | | | | | | | |
| Viscoelasticity | ASTM | E′ | 10.1 | 8.5 | 5.21 | 7.9 | 9.15 | 9.61 | 8.93 |
| 20 Hz, 2% of | D5992- | (N/mm²) | | | | | | | |
| elongation | 96 | Tanδ | 0.198 | 0.145 | 0.123 | 0.148 | 0.152 | 0.145 | 0.139 |
| at room | | | | | | | | | |
| temperature | | | | | | | | | |

The natural rubber-based formulation for the examples in Table 4 was chosen for illustrative purposes as a standard compound for preferential, but not exclusive, use in compounds for rubber components for lorry tyres or other compounds for the rubber industry in general.

From the data on the mechanical properties shown in Table 4 one immediately deduces the surprising reinforcing effect exerted by the activated pyrolytic carbon blacks CBp-1, CBp-2, and CBp-3 according to examples 3-5, compared for example to the commercial CBp. To highlight this surprising reinforcing effect, it is necessary to consider the data relating to the moduli or tensile strength shown in Table 4. One may observe that the values measured for the compounds prepared with the activated CBp-1, CBp-2, and CBp-3 according to examples 3-5 are significantly higher compared to the commercial CBp. This demonstrates the greater reinforcing effect of the activated CBp-1, CBp-2, and CBp-3 according to examples 3-5, thanks to the surface treatments carried out, which make them for all intents and purposes comparable in their performance to the conventional carbon blacks (“furnace” blacks obtained from petroleum) such as N330, N550 and N772, which were studied as reference materials in Table 4. In particular, a comparison between the moduli and tensile strength of the compounds prepared with the activated CBp-1, CBp-2, and CBp-3 according to examples 3-5 shows surprising values, even superior compared to the performances the furnace blacks N772 and N550. The excellent performances of the activated CBp-1, CBp-2, and CBp-3 according to examples 3-5 manifest themselves in the natural rubber-based compound in Table 4 also in terms of high tear strength and minimal abrasion loss, as well as the response to permanent deformation, again compared to the commercial CBp and also compared to the “furnace” blacks N772 and N550. From the viewpoint of viscoelastic properties, the activated CBp-1, CBp-2, and CBp-3 according to examples 3-5 show a low mechanical hysteresis, a property that is highly desirable for application in tyre compounds, where low hysteresis means a reduced dissipation of rolling energy in the form of heat and, ultimately, reduced fuel consumption compared to other carbon blacks, obviously with the compound formulation being equal. For the purposes of application of the natural rubber-based compound in a hypothetical application for a lorry tyre, the high value of the modulus combined with a high tensile strength is one of the qualities desirable for application, since such properties manifest themselves in a long life of the product, and a high tear strength (confirmed for the activated CBp-1, CBp-2, and CBp-3 according to examples 3-5 compared to the commercial CBp in Table 4), as well as an excellent abrasion resistance compared to the commercial CBp, expressed as mm³ of material abraded in the abrasion resistance test, where CBp-1, CBp-2, and CBp-3, activated according to examples 3-5, show volumes of abraded material that are clearly smaller than those measured for the commercial CBp (cf. Table 4). As regards the permanent deformation test, in Table 4 it is possible to observe, for the activated CBp-1, CBp-2, and CBp-3 according to examples 3-5, a lower permanent deformation (property that is desirable for application purposes) compared to commercial CBp. Finally, rebound resilience and viscoelasticity both measure the dynamic mechanical properties of the compounds, and in particular mechanical hysteresis, which, as mentioned, for tyre applications must be as low as possible in order to minimise fuel consumption. The higher elastic modulus (E′), in turn, is also a more marked manifestation of the reinforcing effect exerted by the filler considered, also under dynamic conditions. In table 4 we can in fact see that the compounds prepared with the activated CBp-1, CBp-2, and CBp-3 according to examples 3-5 give rise to an elastic modulus that is decidedly higher compared to a compound containing a commercial CBp. Therefore, the carbon blacks CBp-1, CBp-2, and CBp-3, activated according to examples 3-5, as detailed in the present patent, and comprising acid purification and heat activation, lead to products with surprising reinforcing properties of absolute technological interest, given both the low environmental impact (see Table 1) and the excellent technological performance in a natural rubber compound, as per Table 4.

### Examples 13-19

The pyrolytic carbon black from ELTs CBp-1, prepared according to patent WO2021/079395 A1, and the pyrolytic carbon black CBp-2 and CBp-3, prepared according to what was described in examples 1 and 2, were activated according to examples 3-5 and were subsequently tested in the following standard styrene-butadiene copolymer-based formulation: S1502: 100 phr (“phr” indicates the parts of each component of the formulation added per every 100 parts of rubber, and is the typical method of expressing a rubber formulation used by the person skilled in the art); carbon black: 52 phr (“furnace” blacks, i.e. derived from petroleum, N330, N550 and N772 were used as reference materials, whereas CBp-1, CBp-2, or CBp-3 were the carbon blacks prepared according to examples 3-5; a commercial CBp was also used as a further reference); plasticising oil type T-DAE (Treated Distillate Aromatic Extract, i.e. of an aromatic nature): 5 phr; stearic acid: 1 phr; zinc oxide (3 phr); IPPD (isopropyl-phenyl-p-phenylenediamine) as an antiozonant: 1.5 phr; TMQ (polymerised trimethyl-quinoline) as an antioxidant: 1 phr; sulphur: 1.5 phr, CBS (cyclohexylbenzothiazole-sulfenamide) as an accelerator: 1.0 phr, TBzTD (tetrabenzylthiuram disulfide) as an accelerator: 0.3 phr, and DPG-80 (80% diphenylguanidine) as an accelerator: 0.2 phr.

Each rubber compound of examples 13-19 was prepared using a 1.5 litre laboratory mixer (Banbury) which allows >1 kg of compound to be prepared per batch. The components of the compound as formulated in the previous paragraph were carefully weighed, respecting the proportions of the formulation. The sequence of addition into the mixer first comprised the rubber, which was allowed to be masticated by the machine for a couple of minutes. Then the carbon black, which is the only component that varies from compound to compound in examples 13-19 was added—and the added type is shown in Table 5 for every example—together with the plasticising oil. The carbon black was allowed to blend thoroughly with the rubber and oil and, finally, the zinc oxide, stearic acid, antiozonant agent and antioxidant agent were added. Mixing continued until a homogeneous compound was obtained, which was then unloaded from the Banbury and reduced into a thin layer about 0.5 cm thick by repeated passing through a special mill, known to the person skilled in the art. The compound thus prepared was allowed to cool at room temperature. Once cold, the compound was again loaded into the Banbury and the vulcanising agents (sulphur and the various accelerators) were added after being weighed to respect the proportions of the formulation. Mixing continued until a homogeneous compound was obtained. The compound thus obtained was unloaded from the Banbury and reduced to a thin layer of about 0.5 cm by repeated passing through the mill and it was then allowed to cool at room temperature. For vulcanisation, a quantity of compound sufficient to fill the mould for a test specimen was drawn for technological tests according to ASTM or UNI standards (see Table 5 for the standard followed for each technological test) and it was vulcanised in a press by heating at 160 °C for 15 min in the case of thin test specimens and 20 min in the case of larger test specimens. As mentioned, the technological tests on the vulcanised specimens were carried out according to ASTM or UNI standards. Each standard chosen and applied in the technological test is shown in Table 5.

The styrene-butadiene copolymer-based formulation (SBR) adopted for the examples in Table 5 was chosen for illustrative purposes as a standard compound for preferential, but not exclusive, use in compounds for rubber components for car tyres or other compounds for the rubber industry in general.

In this type of SBR-based polymeric matrix as well, from the data on the mechanical properties shown in Table 5, one immediately deduces the surprising and unexpected reinforcing effect exerted by the pyrolytic carbon blacks CBp-1, CBp-2, and CBp-3 prepared according to examples 3-5 compared, for example, to the reinforcing properties offered by a commercial CBp used as a reference material. In fact, the data relating to the moduli or tensile strength reported in Table 5 show surprisingly higher values in the compounds prepared with the activated CBp-1, CBp-2, and CBp-3 according to examples 3-5 compared to the commercial CBp. This demonstrates the greater reinforcing effect of CBp-1, CBp-2, and CBp-3 thanks to the surface treatments carried out in examples 3-5, which make them for all intents and purposes comparable in their performance to the conventional carbon blacks (“furnace” blacks obtained from petroleum) such as N330, N550 and N772, which were studied as reference materials in Table 5. The surprising and excellent performances of the activated CBp-1, CBp-2, and CBp-3 according to examples 3-5 manifest themselves in Table 5 also in the SBR-type polymeric matrix in terms of tear strength and abrasion loss as well as the response to permanent deformation, with performances decidedly superior to those of a commercial CBp.

From the viewpoint of viscoelastic properties as well, the activated CBp-1, CBp-2, and CBp-3 according to examples 3-5 show a low mechanical hysteresis (tan δ), comparable to or better than that of the carbon blacks from petroleum N330, N550, N772 and of the commercial pyrolytic carbon black CBp. The results obtained with the measurements of the values of tan δ are further corroborated by the measurements of the rebound resilience values. Low mechanical hysteresis is highly desirable in tyre applications because directly tied to a reduction in fuel consumption.

TABLE 5
Styrene-butadiene copolymer-based compounds (SBR)

| | | | comparative | comparative | comparative | comparative | | | |
|---|---|---|---|---|---|---|---|---|---|
| | | | example | example | example | example | | | |
| | | | 13 | 14 | 15 | 16 | | | |
| Vulcanised | | | N330 | N550 | N772 | Commercial | example | example | Example |
| at 160 °C-15 | | Unit of | comparative | comparative | comparative | CBp | 17 | 18 | 19 |
| min | Method | measurement | test | test | test | comparative test | CBp-1 | CBp-2 | CBp-3 |
| Hardness | ASTM D | Sh/A3 | 61 | 60 | 57 | 57 | 57 | 59 | 61 |
| (Shore A) | 2240-15 | | | | | | | | |
| Density of | ASTM D | g/cm³ | 1.123 | 1.123 | 1.121 | 1.125 | 1.125 | 1.122 | 1.122 |
| vulcanised | 792-20 | | | | | | | | |
| rubber | | | | | | | | | |
| Tensile | ASTM D | Mpa | 18.9 | 15.3 | 13.0 | 10.6 | 13.5 | 15.2 | 17.8 |
| Strength | 412-16 | | | | | | | | |
| Modulus at | ASTM D | Mpa | 2.02 | 2.67 | 1.68 | 1.7 | 1.76 | 2.01 | 2.52 |
| 100% | 412-16 | | | | | | | | |
| elongation | | | | | | | | | |
| Modulus at | ASTM D | Mpa | 9.95 | 11.4 | 6.52 | 5.67 | 5.12 | 6.65 | 8.54 |
| 300% | 412-16 | | | | | | | | |
| elongation | | | | | | | | | |
| Elongation at | ASTM D | % | 481 | 400 | 520 | 487 | 540 | 523 | 485 |
| Break | 412-16 | | | | | | | | |
| Tear Strength | ASTM D | kN/m | 81 | 63 | 53 | 53 | 63 | 67 | 72 |
| | 624-00 | | | | | | | | |
| | B | | | | | | | | |
| Abrasion Loss | UNI | mm³ | 92 | 101 | 188 | 175 | 114 | 107 | 102 |
| | 9185- | | | | | | | | |
| | 2008 | | | | | | | | |
| Rebound | UNI | % | 48 | 55 | 61 | 56 | 59 | 59 | 61 |
| Resilience | 7716- | | | | | | | | |
| | 2000 | | | | | | | | |
| Permanent | ASTM | % | 14 | 14 | 11 | 16 | 14 | 13 | 12 |
| Deformation | D395- | | | | | | | | |
| under | 18 B | | | | | | | | |
| compression | | | | | | | | | |
| (70 °C) | | | | | | | | | |
| Viscoelasticity | ASTM | E′ (N/mm²) | 9.3 | 7.5 | 3.89 | 4.25 | 5.52 | 6.54 | 7.05 |
| 20 Hz, 2% of | D5992- | Tanδ | 0.239 | 0.174 | 0.158 | 0.171 | 0.163 | 0.163 | 0.160 |
| elongation at | 96 | | | | | | | | |
| room | | | | | | | | | |
| temperature | | | | | | | | | |

Furthermore, in terms of the elastic modulus E′, the three CBps of the patent surpass, in performance, both the commercial CBp and the carbon black ASTM N772 and this result as well is a confirmation of the better reinforcing action also under dynamic conditions.

### Examples 20-26

The pyrolytic carbon black from ELTs CBp-1, prepared according to patent WO2021/079395 A1, and the pyrolytic carbon blacks CBp-2 and CBp-3, prepared according to examples 1 and 2 and activated according to examples 3-5, were subsequently tested in the following standard acrylonitrile-butadiene copolymer-based formulation: NBR3345: 100 phr (“phr” indicates the parts of each component of the formulation added per every 100 parts of rubber, and is the method of expressing a rubber formulation typical of the sector); carbon black: 52 phr (the “furnace” blacks, i.e. derived from petroleum, were N330, N550 and N772 and were used as reference materials, whereas the carbon blacks prepared according to the invention were CBp-1, CBp-2, or CBp-3; a commercial CBp was also used as a further reference); plasticising agent type DINP (diisononyl phthalate): 5 phr; stearic acid: 1 phr; zinc oxide (3 phr); IPPD (Isopropyl-phenyl-p-phenylenediamine) as an antiozonant: 1.5 phr; TMQ (polymerised trimethyl-quinoline) as an antioxidant: 1 phr; sulphur: 1.5 phr, CBS (cyclohexylbenzothiazole-sulfenamide) as an accelerator: 1.0 phr; and TBzTD (tetrabenzylthiuram disulfide) as an accelerator: 0.3 phr.

Each rubber compound of examples 20-26 was prepared using a 1.5 litre laboratory mixer (Banbury) which allows >1 kg of compound to be prepared per batch. The components of the compound as formulated in the previous paragraph were carefully weighed, respecting the proportions of the formulation. The sequence of addition into the mixer first comprised the rubber, which was allowed to be masticated by the machine for a couple of minutes. Then the carbon black (which is the only component that varies from compound to compound in examples 20-26; the type added is shown in Table 6 for every example) was added together with the plasticising oil. The carbon black was allowed to blend thoroughly with the rubber and oil and, finally, the zinc oxide, stearic acid, antiozonant agent and antioxidant agent were added. Mixing continued until a homogeneous compound was obtained, which was then unloaded from the Banbury and reduced into a thin layer about 0.5 cm thick by repeated passing through a special mill, known to the person skilled in the art. The compound thus prepared was allowed to cool at room temperature. Once cold, the compound was again loaded into the Banbury and the vulcanising agents (sulphur and the various accelerators) were added after being weighed to respect the proportions of the formulation. Mixing continued until a homogeneous compound was reached. The compound thus obtained was unloaded from the Banbury and was reduced to a thin layer of about 0.5 cm by repeated passing through the mill and then allowed to cool at room temperature. For vulcanisation a quantity of compound sufficient to fill the mould for a test specimen was drawn for technological tests according to ASTM or UNI standards (see Table 6 for the standard followed for each technological test) and it was vulcanised in a press by heating at 160 °C for 15 min in the case of thin test specimens and 20 min in the case of larger test specimens. The technological tests on the vulcanised specimens were carried out according to ASTM or UNI standards. Each standard chosen and applied in the technological test is shown in Table 6.

The acrylonitrile-butadiene copolymer-based compound (NBR) adopted for the examples in Table 6 was chosen for illustrative purposes as a standard compound for moulded technical articles made of rubber in applications other than tyres. In other words, with this NBR-based compound it is intended to show that the activated pyrolytic carbon blacks CBp-1, CBp-2, and CBp-3 according to examples 3-5, give rise to surprising technical advantages also if applied as reinforcing materials in compounds other than those for tyres and thus specific for technical articles in general.

As shown in Table 6, in the NBR-based polymeric matrix, too, as already seen for the previous NR- and SBR-based matrices, the pyrolytic carbon blacks CBp-1, CBp-2, and CBp-3 confirm the surprising and excellent reinforcing effect already previously observed in the natural rubber- and SBR-based compounds compared, for example, to a commercial CBp. In fact, from the data relating to the moduli or tensile strength shown in Table 6, one may observe that the values measured for the compounds prepared with the activated CBp-1, CBp-2, and CBp-3 according to examples 3-5, are significantly higher compared to the commercial CBp. This demonstrates the greater reinforcing effect of CBp-1, CBp-2, and CBp-3 thanks to the surface treatments carried out, which make them for all intents and purposes comparable in their performance to the conventional “furnace” blacks derived from petroleum currently in use.

TABLE 6
Acrylonitrile-butadiene copolymer-based compounds (NBR)

| | | | comparative | comparative | comparative | comparative | | | |
|---|---|---|---|---|---|---|---|---|---|
| | | | example | example | example | example | | | |
| | | | 20 | 21 | 22 | 23 | | | |
| | | | N330 | N550 | N772 | Commercial | example | example | example |
| Vulcanised at | | Unit of | comparative | comparative | comparative | CBp | 24 | 25 | 26 |
| 160 °C-15 min | Method | measurement | test | test | test | comparative test | CBp-1 | CBp-2 | CBp-3 |
| Hardness (Shore | ASTM D | Sh/A3 | 60 | 59 | 56 | 55 | 55 | 58 | 60 |
| A) | 2240-15 | | | | | | | | |
| Density of | ASTM D | g/cm³ | 1.127 | 1.127 | 1.124 | 1.129 | 1.128 | 1.127 | 1.127 |
| vulcanised | 792-20 | | | | | | | | |
| rubber | | | | | | | | | |
| Tensile Strength | ASTM D | Mpa | 20.1 | 18.1 | 16.9 | 14.2 | 15.4 | 17.3 | 19.0 |
| | 412-16 | | | | | | | | |
| Modulus at | ASTM D | Mpa | 2.15 | 2.38 | 1.92 | 1.83 | 1.91 | 2.18 | 2.25 |
| 100% elongation | 412-16 | | | | | | | | |
| Modulus at | ASTM D | Mpa | 8.85 | 10.2 | 7.15 | 6.61 | 6.66 | 7.01 | 8.05 |
| 300% elongation | 412-16 | | | | | | | | |
| Elongation at | ASTM D | % | 495 | 465 | 560 | 555 | 586 | 575 | 525 |
| Break | 412-16 | | | | | | | | |
| Rebound | UNI | % | 39 | 45 | 49 | 46 | 49 | 49 | 50 |
| Resilience | 7716- | | | | | | | | |
| | 2000 | | | | | | | | |
| Permanent | ASTM | % | 15 | 15 | 13 | 15 | 13 | 12 | 11 |
| Deformation | D395-18 | | | | | | | | |
| under | B | | | | | | | | |
| compression | | | | | | | | | |
| (70 °C) | | | | | | | | | |

The NBR-based formulation of examples 20-26 is a compound for technical articles essentially designed for static applications. It is for this reason that neither the viscoelastic properties nor abrasion resistance were measured. However, in this case as well, CBp-1, CBp-2, and CBp-3 show a better mechanical hysteresis compared to the commercial CBp as measured by the rebound resilience. Also in terms of permanent deformation, the activated CBp-1, CBp-2, and CBp-3 according to examples 3-5 surpass the commercial CBp in performance thanks to a lower permanent deformation.

It was thus found, and is therefore an object of the present patent, that the pyrolytic carbon blacks obtained from used tyres CBp-1, CBp-2, and CBp-3—the latter two purified beforehand in order to remove undesirable components (zinc, transition metals and sulphur in the case of the CBp-2 and also silica in CBp-3)—and all activated according to examples 3-5, once tested as reinforcing materials in compounds based on natural rubber or cis-1,4-polyisoprene (NR or IR) (examples 6-12), based on styrene-butadiene copolymer (SBR) (examples 13-19) or based on acrylonitrile-butadiene copolymer (NBR) (examples 20-26), give rise (in all cases) to surprising and excellent reinforcing effects, measured by the values of the moduli and of tensile strength, such as to completely outclass the performances of a commercial CBp and equal or even surpass the performances of certain “furnace” blacks obtained from petroleum, such as, for example, N772, N550 and N330. The surprising performances of the activated CBp-1, CBp-2, and CBp-3 according to examples 3-5, and the object of the present patent, also extend to other mechanical properties, such as the excellent tear strength, minimal abrasion loss, limited permanent deformation and low mechanical hysteresis measured in terms of tan δ and rebound resilience, and completely outclass the performances of the commercial CBp as well as those of certain “furnace” blacks, such as, for example, N772, and also N550 in some respects.

1.-12. (canceled)

13. A process for recovering carbon black obtained from the pyrolysis of used tyres, comprising the following steps:
a heat treatment of the carbon black in an inert atmosphere, at a temperature comprised between 550 °C and 800 °C, to obtain a purified carbon black (CBp-1),
an activation of the surface of the purified carbon black at a temperature between 800 °C and 1000 °C, using reactive gases selected from the group consisting of: nitrogen, argon, carbon dioxide, superheated steam, and mixtures thereof.

14. The process for recovering carbon black obtained from the pyrolysis of used tyres according to claim 13, further comprising, after said heat treatment step and before said step of activation of the surface of the purified carbon black:
a selective extraction of zinc from the purified carbon black (CBp-1) using an aqueous solution comprising a carboxylic acid selected from: citric acid and tartaric acid or an inorganic acid selected from hydrochloric acid and sulphuric acid, preferably an inorganic acid selected from hydrochloric acid and sulphuric acid, to obtain a purified carbon black with a low zinc and sulphur content (CBp-2), or to obtain a purified carbon black with a low zinc content (CBp-2).

15. The process for recovering carbon black obtained from the pyrolysis of used tyres according to claim 14, wherein said aqueous solution further comprises hydrofluoric acid, in combination with said carboxylic acid or inorganic acid, to obtain a purified carbon black with a low silica content (CBp-3).

16. The process for recovering carbon black obtained from the pyrolysis of used tyres according to claim 13, wherein said heat treatment in an inert atmosphere takes place at a temperature between 600 °C and 780 °C.

17. The process for recovering carbon black obtained from the pyrolysis of used tyres according to claim 13, wherein said heat treatment in an inert atmosphere takes place under a stream of an inert gas selected from: N₂, Ar, CO₂, superheated steam, and combinations thereof.

18. The process for recovering carbon black obtained from the pyrolysis of used tyres according to claim 13, wherein said step of activation of the surface of the purified carbon black using reactive gases is carried out by means of a flow of CO₂ and/or superheated steam between 150 and 400 ml/min, with a heating ramp between 10°/min and 40 °C/min, up to a final temperature comprised between 800 °C and 950 °C, with a dwell time at that final temperature between 30 and 60 minutes.

19. A recovered carbon black as obtained from the process of claim 13.

20. Use of the recovered carbon black of claim 19 in the production of rubber compounds.

21. A rubber compound based on natural rubber (NR, cis-1,4-polyisoprene), comprising the recovered carbon black of claim 19.

22. A rubber compound based on styrene-butadiene copolymer (SBR),
comprising the recovered carbon black of claim 19.

23. A rubber compound based on acrylonitrile-butadiene copolymer (NBR), comprising the recovered carbon black of claim 19.

24. A rubber compound based on mixtures of natural rubber (NR, cis-1,4-polyisoprene) and/or styrene-butadiene copolymer (SBR) and/or polybutadiene homopolymer (BR) and/or acrylonitrile-butadiene copolymer (NBR) and/or ethylene-propylene-diene copolymer (EPDM) and/or ethylene-propylene copolymer (EPM) and/or chloroprene or neoprene rubber and/or butyl rubber and/or chlorobutyl rubber and/or bromobutyl rubber and/or ethylene-vinyl acetate rubber and/or chlorinated polyethylene and/or chlorosulphonated polyethylene rubber and/or acrylic rubber and/or epichlorohydrin rubber and/or fluoroelastomer rubber and/or silicone rubber and/or fluorosilicone rubber and/or polyester and polyether rubber and/or polyurethane elastomers and/or thermoplastic elastomers in general, comprising the recovered carbon black of claim 19.
